(19) United States
(12) Patent Application Publication
(10) Pub. No.: US 2014/0204458 A1
(43) Pub. Date: Jul. 24, 2014

(54) POLARIZATION-MAINTAINING MODULE FOR MAKING OPTICAL SYSTEMS POLARIZATION-INDEPENDENT

(71) Applicants: Daniel Côté, Québec (Québec) (CA); Erik Bélanger, Quebec (Quebec) (CA); Raphaël Turcotte, Somerville, MA (US); Steve Bégin, Quebec (Quebec) (CA)

(72) Inventors: Daniel Côté, Québec (Québec) (CA); Erik Bélanger, Quebec (Quebec) (CA); Raphaël Turcotte, Somerville, MA (US); Steve Bégin, Quebec (Quebec) (CA)

(73) Assignee: UNIVERSITE LAVAL, Quebec (CA)

(21) Appl. No.: 14/240,563

(22) PCT Filed: Aug. 30, 2012
(86) PCT No.: PCT/CA2012/050599

§ 371 Date: Feb. 24, 2014

Related U.S. Application Data
(60) Provisional application No. 61/530,563, filed on Sep. 2, 2011.

(51) Int. Cl. G02B 5/30

(52) U.S. Cl. CPC G02B 5/30
USPC 359/487.01; 29/428

(57) ABSTRACT

Polarization compensation in optical system having a primary optical element having polarization-altering characteristics, such as a dichroic element, is provided. A compensation optical element having substantially the same polarization-altering characteristics as the primary optical element is provided in the path of the light beam whose polarization state is to be conserved. The compensation optical element is oriented with respect to the light beam such that by transmitting or reflecting the light beam, it alters its polarization state in a manner opposite to the altering of this polarization state by the primary optical element. Advantageously, this is true for any orientation of the polarization state of the light beam.

### FIELD OF THE INVENTION

The present invention concerns optical systems such as microscopic and spectroscopic-based systems and the like and more particularly concerns a module for use in such systems that conserves polarization state.

### BACKGROUND

The polarization of light can be an issue in many optical systems. This is for example the case for microscopes and spectroscopic systems which are commonly used to observe biological structures and phenomena such as cells, tissues and the like.

Such systems can be based on several approaches. For example, Sum-Frequency Imaging Microscopy (SFIM) involves the concept known as Sum-Frequency

Generation (SFG), where two or more photons combine to form a photon having the sum of their respective energy, and therefore a shorter wavelength. A SFG microscope therefore observes the ability of a sample under study to generate sum frequency light from light incident thereon. A special case of Sum-Frequency generation is Second-Harmonic Generation (SHG) where the two incident photons have the same wavelength and the resulting photon has exactly half that wavelength, i.e. twice the energy. Another approach is Two-Photon Fluorescence (TPF), also known as Two-Photon Excitation Microscopy (TPEM), a fluorescence imaging technique which is based on the idea that two photons, each having about half of the energy required to excite a fluorophore molecule, combine to excite the fluorophore in one quantum event. The fluorophore then transitions to a lower level through the emission of a fluorescence photon, which is observed by the microscope. Yet another approach, known as Coherent Anti-Stokes Raman Scattering (CARS), requires the combination of two or more light-fields, one or two pump fields and a Stokes field. When interacting with the probed molecules, the pump and Stokes fields stimulate the creation of a third field, called anti-Stokes, which defines the detected CARS signal. The difference in frequency of the pump and Stokes fields is set to a chemically specific vibration leading to a Raman shifted photon emission. In its simplest form, 1-photon confocal microscopy requires a single light field for excitation, but many variations include other fields (e.g., Stimulated Emission Microscopy) to exploit a particular physical property of the light-sample interaction (fluorescence, absorption, scattering, etc.).

Techniques such as those described above and the like often involve light beams at different wavelengths circulating within the system. It is well known in the art to use dichroic elements to separate these light fields. Dichroic elements can be constructed to transmit light within a certain wavelength range and reflect light within another wavelength range, making them ideal for such a context.

A difficulty however arises with the use of dichroic elements when the polarization of one or several of the light beams needs to be conserved. This is for example the case when using CARS for myelin morphometric measurements. The CARS signal intensity depends on the relative angle between the macroscopic average molecular dipole orientation and the incident Stokes and pump field polarization orientation. The dichroic element used to separate the Stokes and pump fields from the CARS signal alters the polarization of all of these signals as a result of the different phase retardation imparted on the s and p polarization components of the light fields as they propagate through or are reflected off the dichroic element.

FIG. 1 (PRIOR ART) schematically illustrates the basic configuration of a CARS imaging microscopic system 10 according to prior art. The Stokes and pump fields from a scanning unit (not shown) are reflected by an input mirror 22 towards a primary dichroic element 24, which transmits light at both the Stokes and pump wavelengths. Both fields are initially linearly polarized. After having travelled through the primary dichroic element 24, however, both fields have become elliptically polarized as a result of the polarization-altering characteristics of the dichroic element. They are then focussed by a microscope objective 26 on the sample under study (not shown), which emits the CARS signal as a result. The CARS signal has a wavelength which is reflected by the primary dichroic element 24, and will therefore be deflected thereby towards a detector (not shown). As the polarization of the CARS signal is related to the polarization of the Stokes and pump fields, it will also be affected by the polarization changes in the incident beams, and be further altered upon reflection off the dichroic element.

Several approaches have been devised to address the difficulties resulting from undesired polarization alterations in such systems. These approaches however usually involve a precompensation of the polarization alterations using complex combinations of half-wave and quarter-wave plates and long calibration procedures.

Methods were developed and applied to compensate for polarization issues for the SHG and TPF approaches described above. It is for example known from CHU et al. (“Studies of chi(2)/chi(3) tensors in submicron-scaled bio-tissues by polarization harmonics optical microscopy”, Biophysical Journal, 86(6), 3914-22 (2004)) to use a rotation of the specimen instead of polarization rotation. This method, which can be challenging to implement in practice, takes advantage of the fact that the polarization of the light fields incident along one of the s and p dichroic axes is not altered by the interaction with the dichroic element. Also using this fact, it is also known from MANSFIELD et al. (“Collagen fiber arrangement in normal and diseased cartilage studied by polarization sensitive nonlinear microscopy”, Journal of Biomedical Optics, 13(4), 044020 (2008)) to rotate the light fields using a single half-wave plate positioned downstream the dichroic, just in front of the objective. This technique however does not allow for emitted light polarization dependence experiments and would be difficult to implement in a commercial microscope system. Furthermore, compensation schemes using a half- and quarter-wave plates require calibration tables which are time consuming to obtain, and vary with regard to the alignment of the components of a particular system (see Chou et al, “Polarization ellipticity compensation in polarization second-harmonic generation microscopy without specimen rotation”, Journal of Biomedical Optics, 13(1), 014005 (2008)). It is also necessary to rotate four plates for every measurement at a different incident polarization orientation when using this approach for PD-CARS.

Polarization-related difficulties are not limited to microscopic and spectroscopic systems. Any other optical systems using a dichroic element or other optical element altering the polarization of light interacting therewith may benefit from a compensation of such effects if the polarization state needs to be maintained.

There therefore remains a need for a manner of addressing polarization issues in optical systems which alleviates at least some of the drawbacks of the prior art.

### SUMMARY OF THE INVENTION

In accordance with one aspect of the invention, there is provided a polarization-maintaining module for an optical system in which propagates a light beam having a polarization state out of multiple possible polarization states.

The polarization-maintaining module includes a primary optical element having polarization-altering characteristics. The primary optical element is functionally disposed within the optical system to transmit or reflect the light beam, the transmitting or reflecting of the light beam altering the polarization state thereof according to the polarization-altering characteristics.

The polarization-maintaining module further includes a compensation optical element disposed in a path of the light beam to transmit or reflect the same. The compensation optical element has substantially the same polarization-altering characteristics as the primary optical element. The compensation optical element is oriented with respect to the light beam such that the transmitting or reflecting of the light beam thereby alters the polarization state of the light beam in a manner opposite to the altering of this polarization state by the primary optical element, for any one of the possible polarization states.

In some embodiments, the primary and compensation optical elements are dichroic elements or filters having an anti-reflection layer. Any other optical element having polarization-altering characteristics which need to be taken under consideration could also be used.

In one embodiment, each of the primary and compensation optical elements has an incidence surface on which the light beam impinges along a corresponding impinging direction. The normal vector to each incidence surface and the corresponding impinging direction define together a plane of incidence. The compensation optical element is oriented such that its plane of incidence is orthogonal to the plane of incidence of the primary optical element.

Advantageously, polarization-maintaining modules according to embodiments of the invention may be easily integrated into or added to commercially available optical systems such as microscopes or spectroscopic systems of other systems.

In some embodiments, there is provided the use of a polarization-maintaining module as above in an optical system configured as one of a Second-Harmonic Imaging microscope, a One-Photon or Multiphoton Excitation Fluorescence or phosphorescence system, a Coherent Anti-Stokes Raman Scattering system, a Stimulated Raman Scattering system, a Sum-Frequency Generation system, a Raman spectroscopic system, an Infrared spectroscopic system, a Polarization spectroscopic system and a Stimulated Emission Depletion Microscope.

In another aspect of the invention there is provided a method for making polarization-independent an optical system having as input or output a light beam having a polarization state out of multiple possible polarization states. The optical system includes a primary optical element having polarization-altering characteristics, the primary optical element being functionally disposed within the optical system to transmit or reflect the light beam. The transmitting or reflecting of the light beam alters its polarization state according to the polarization-altering characteristics of the primary optical element.

The method first includes providing a compensation optical element having substantially the same polarization-altering characteristics as the primary optical element.

The method also includes disposing the compensation optical element in a path of the light beam upstream or downstream the optical system, to transmit or reflect the light beam. The compensation optical element is oriented with respect to the light beam such that the transmitting or reflecting of the light beam thereby alters its polarization state in a manner opposite to the altering of this polarization state by the primary optical element of the optical system, for any one of the possible polarization states.

The compensation optical element may be integrated inside the optical system or combined therewith as an external component. Additional optical components such as mirrors, lens, beamsplitters or the like may be additionally provided to further affect or redirect light within the system. In some embodiments, more than one compensation optical elements may be added to a given optical system, for example to correct both the reflected and the transmitted light from a given primary optical element, and/or paired with different primary optical elements within the system.

In one example, the method may involve providing a casing having a light input and a light output, the compensation optical element being mounted therein according to a predetermined orientation with respect to the light input and output.

Embodiments of the present invention offer many advantages over known compensation schemes for compensating polarization issues in optical systems of various types. The compensation effect is linear, can be obtained for several light beams at the same time, and is independent of the wavelength and initial polarization state of the light beam. No moving part or complex calibration procedure is required.

Further features and advantages of the invention will be better understood upon a reading of embodiments thereof with reference to the enclosed drawings.

### BRIEF DESCRIPTION OF THE DRAWINGS

FIG. 1 (PRIOR ART) is a schematic side view of a Coherent Anti-Stokes Raman Spectroscopy (CARS) configuration according to prior art.

FIGS. 2A and 2B are schematic side and top views, respectively, of a CARS configuration according to one embodiment.

FIG. 3 is a graph illustrating the factors typically used to describe the polarization of light incident on a surface of an optical component.

FIG. 4A is a perspective view of a polarization-maintaining module for use in transmission according to one embodiment of the invention. FIG. 4B is a top view of the polarization-maintaining module of FIG. 4A. FIG. 4C is a side view of the polarization-maintaining module of FIG. 4A.

FIG. 5A is a perspective view of a polarization-maintaining module for use in reflection according to one embodiment of the invention. FIG. 5B is a front view of the polarization-maintaining module of FIG. 5A. FIG. 5C is a side view of the polarization-maintaining module of FIG. 5A.

FIG. 6 is a schematic side view of a pre-existing optical system made polarization-independent according to an embodiment of the invention.

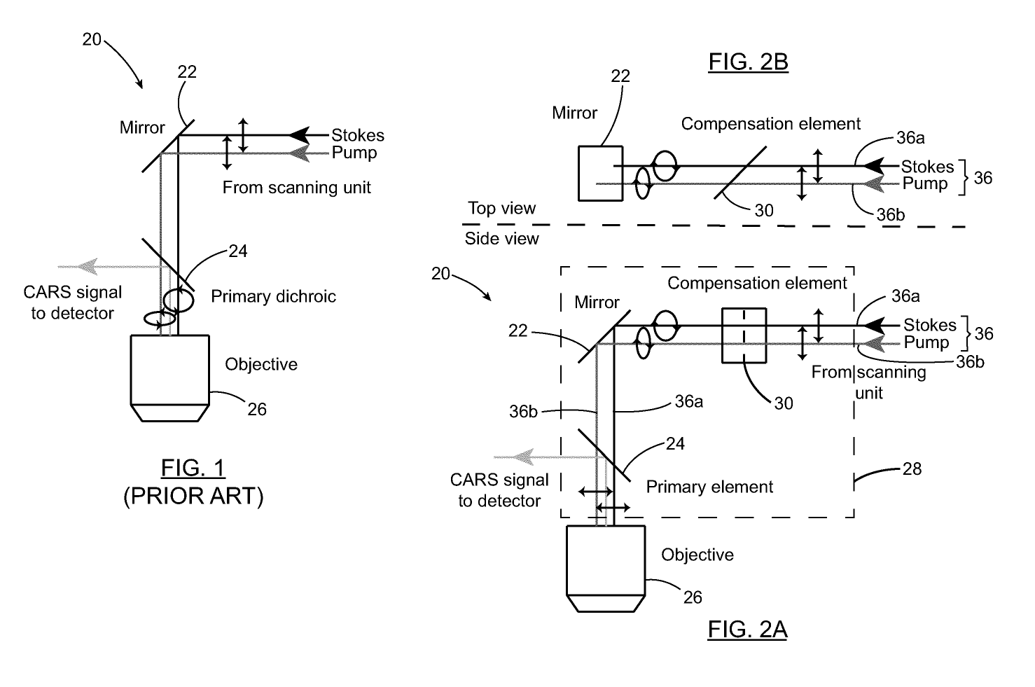

### DETAILED DESCRIPTION OF EMBODIMENTS

In accordance with one aspect of the invention, there is provided a polarization-maintaining module for an optical system.

The optical system to which the present invention may be applied can be embodied by any system using a primary optical element altering the polarization of light interacting therewith. One or more light beams propagate in the system. Embodiments of the invention are for example suitable where a light beam having a polarization state out of multiple possible polarization states propagates in the system, and where this polarization state needs to be maintained, regardless of what it is. One skilled in the art will readily understand that it is not necessary for the polarization state to be known and determined, as embodiments of the invention allow for the compensation of any one of the multiple possible polarization states which can be carried by the light propagating in the system.

The optical system may be used for microscopic or spectroscopic measurements, but it will be readily understood that the invention is not limited to this type of applications. In one example, dichroic elements are generally used to separate two light fields having different wavelengths, and any optical system where such a need is present is considered within the scope of the present description. A non-exhaustive list of such systems includes a Second-Harmonic Imaging microscope, a One-Photon or Multiphoton Excitation Fluorescence or phosphorescence system, a Coherent Anti-Stokes Raman Scattering system, a Stimulated Raman Scattering system, a Sum-Frequency Generation system, or the like. In other examples, the system may be embodied by Raman spectroscopic system, Infrared spectroscopic system, Polarization spectroscopic system, Stimulated Emission Depletion Microscope, or the like.

Referring to FIGS. 2A and 2B, there is respectively shown a side and top view of the basic configuration of a Coherent Anti-Stokes Raman Scattering (CARS) microscopic optical system 20 provided with a polarization-maintaining module 28 according to an embodiment of the invention. It will be understood that this particular configuration is shown for illustrative purposes only, and is in no way considered limitative to the scope of the present invention.

The polarization-maintaining module 28 first includes a primary optical element 24, here embodied by a dichroic element, which is functionally disposed within the optical system 20 to transmit a light beam 36 whose polarization state is to be maintained. In the illustrated embodiment The light beam 36 is composed of two light beams components 36a and 36b transmitted by the primary optical element 24, corresponding to the Stokes and pump fields. By “functionally disposed”, it will be understood that the primary optical element 24 is positioned within the optical system 20 to interact with light in some manner according to the design of the optical system 20. In the illustrated embodied, the function of the primary optical element 24 is to separated light fields according to its dichroic properties, reflecting light within a certain spectral range and transmitting light within another spectral range. The primary optical element 24 may be disposed with the optical system 20 according to any appropriate configuration, again depending on the particular design of the optical system 20. In the illustrated example of FIGS. 2A and 2B, the primary dichroic element 24 is transmissive to the pump and Stokes lights fields and reflective to the CARS signal, and is positioned accordingly within the path of these light fields.

The primary optical element 24 may be embodied by any appropriate device having the desired transmission and/or reflection characteristics. It can be embodied by a dichroic filter, which transmits light within a specific wavelength range and reflects light at other wavelengths, or a dichroic mirror, which is conversely designed to reflect light within a specific wavelength range and transmit light at other wavelengths. Dichroic elements are generally made of successive thin-film layers of different thicknesses having different refractive indices optimized in such a way to tailor the spectral characteristics of the reflected and transmitted beams. By design, this usually implies that s and p polarized light will experience different phase shifts and amplitude modulation. It will be readily understood that other types of optical elements also exhibit the same properties and could embody the primary optical element in other implementations, such as filters provided with an anti-reflection layer, or the like.

The primary optical element 24 has polarization-altering characteristics, and the transmitting or reflecting of the light beam 36 alters its polarization state according to these characteristics. By “polarization-altering”, it is understood that the primary optical element 24 will affect light which is transmitted and/or reflected thereby so as to modify its polarization state in a consistent, but not necessarily known, manner. In other words, the polarization state of light reflected or transmitted by the primary optical element 24 becomes different than it was prior to this interaction, in a manner significant enough to negatively impact at least some aspect of the operation of the optical system 20. In various embodiments, these polarization-altering characteristics are not present by design but are undesirable side effects of other properties of the primary optical element 24.

The “polarization state” of a light beam refers to the direction of oscillation of its electrical field, which is orthogonal to the propagation direction of the light. Light is said to be linearly polarized when its electrical field oscillates along a single direction (or axis). If the direction of oscillation rotates around the propagation axis, the light field is said to be elliptically polarized (circular polarization is a special case of elliptical polarization where the strength of the field is the same in every direction).

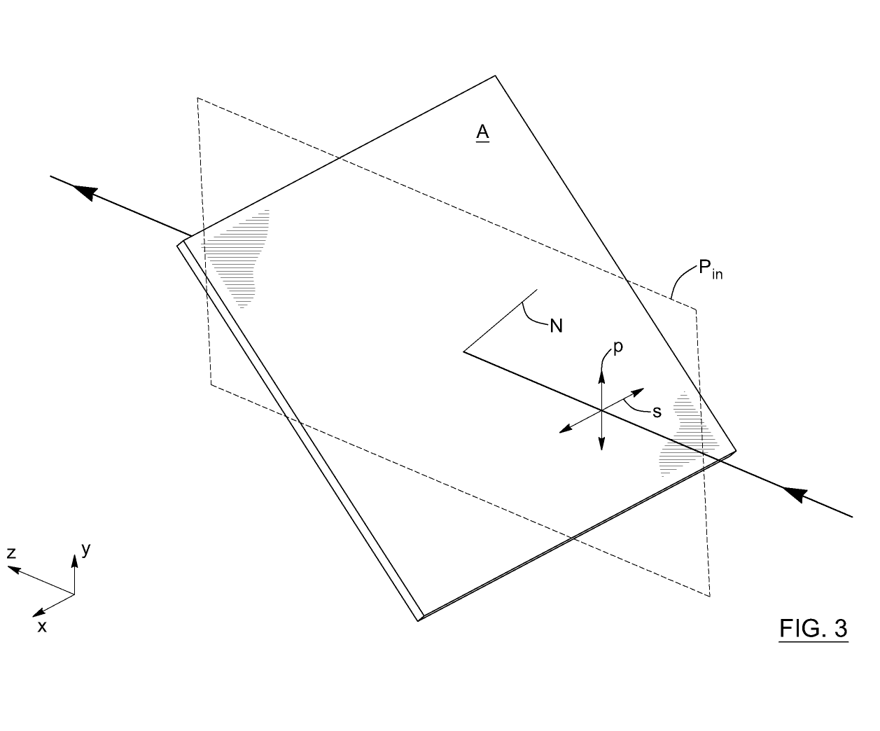

Referring to FIG. 3, the factors typically used to describe the polarization of light incident on a surface A of an optical component are schematically illustrated. Light incident on the surface A has an initial polarization state which can be defined as a function of its “s” and “p” polarization components. These components are not intrinsic to the light beam but defined with respect to the plane of incidence Pᵢₙ of the light beam on the surface A, this plane of incidence being defined as the plane containing both the propagation axis Z and a vector N normal to the surface A. By convention, the “p” polarization component of the incident light is aligned with the plane of incidence Pᵢₙ, whereas the “s” polarization component is perpendicular thereto.

When a light beam is either transmitted or reflected by an optical element having polarization-altering characteristics, the incident s and p polarization components travel at different speeds and experience different reflection and transmission coefficients at each sub-interface, leading to phase retardation and an amplitude modulation between these components. Therefore, any incident light beam having an initial polarization state other than strictly s or strictly p will be transmitted or reflected by the optical element with a final polarization state different than the initial one. For example, an initially linearly polarized light beam may be transformed into an elliptically polarized beam.

Referring back to FIGS. 2A and 2B, the polarization-maintaining module 28 according to an embodiment of the invention includes a compensation optical element 30. The compensation optical element 30 has substantially the same polarization-altering characteristics as the primary optical element 24, that is, both optical elements 24 and 30 alter the polarization state of a given incident light beam 36 in the same manner. It will be readily understood that slight differences in the polarization-altering properties of the primary and optical elements 24 and 30 may be considered within the scope of the expression “substantially the same”, inasmuch as these differences do not affect significantly the operation of the polarization-maintaining module 28.

In the case of dichroic elements, polarization-altering characteristics are believed to be related to the dichroic properties, that is, two dichroic elements of a same model or fabricated using the same method are likely to have substantially the same polarization-altering characteristics. It is similarly believed that the same principle can apply to other optical elements which have optical properties affecting differently the s and p polarization components of light.

The compensation dichroic element 30 is disposed in the path of the light beam 36 whose polarization state is to be conserved, to either reflect or transmit the same. It will be readily understood that the compensation optical element 30 preferably interacts with the light beam 36 in the same manner as the primary optical element 24, that is, they either both transmit or both reflect the light beam 36. Furthermore, the compensation optical element 30 is oriented with respect to the light beam 36 such that when this light beam 36 is transmitted or reflected by the compensation optical element 30, the latter alters the polarization state of the light beam 36 in a manner opposite to the altering of this polarization state by the primary optical element 24. This is true for any one of the possible polarization states of the light beam 36.

In the example of FIGS. 2A and 2B, the compensation optical element 30 is disposed in the path of the Stokes and pump fields 36a and 36b transmitted by the primary optical element 24. The polarization state of each of these light beams is therefore maintained in the system 20. Although the compensation optical element 30 is shown here to intercept a light beam 36 having two components 36a and 36b, it will be readily understood that in other configurations it could intercept a single or more than two light beam components without departing from the scope of the present invention.

Depending on the physical requirements of different embodiments, the compensation optical element 30 can be disposed either upstream or downstream the primary optical element 24. In the illustrated embodiment of FIGS. 2A and 2B, in the illustrated CARS configuration, the compensation optical element 30 is positioned upstream the primary optical element 24. In the illustrated configuration, the input Stokes and pump fields 36a, 36b typically have an initially linear polarization state which is transformed into distinct elliptical states by the compensation optical element 30, and upon transmission by the primary dichroic element 24 both fields will be transformed back to their initial linear polarization state. In such a configuration, the compensation optical element in effect “pre-corrects” the polarization state of the light beam 36. Advantageously, the compensation effect is independent of wavelength, that is, it will be achieved no matter the wavelength of the compensated light beam, and will work simultaneously and equally well for light beams of different wavelengths as is the case in the illustrated example with the pump and Stokes fields. The compensation effect is also independent of the initial polarization state of the compensated light beam; the resulting polarization state after transmission or reflection by both optical elements matches the initial polarization state, whatever it is. Therefore, it is not even necessary to have knowledge of the initial polarization state to successfully maintain it.

As will be readily understood by one skilled in the art, the configuration of FIGS. 2A and 2B is shown by way of example only, and a great number of other configurations are possible without departing from the scope of the present invention. Indeed, the compensation and primary optical elements may be positioned in direct line of sight of each other, or separated by one or more optical components which may direct, shape or otherwise affect light as may be required by the geometry or nature of the configuration of the system. Of course, such additional optical components should not affect polarization in such a manner as to lose the polarization-maintaining advantages of the present invention.

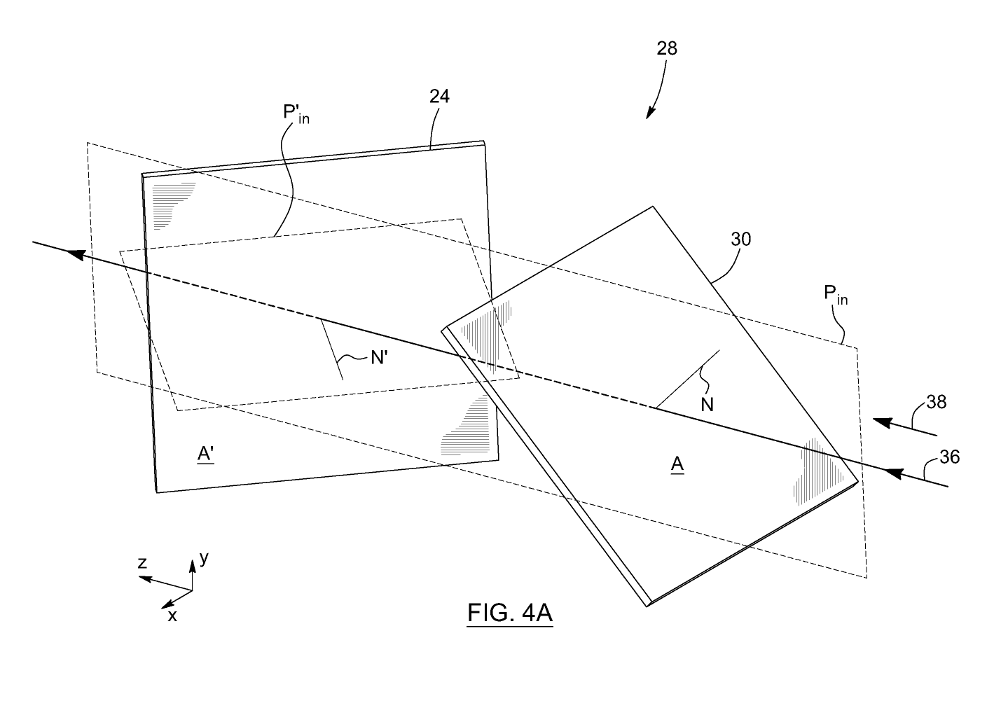

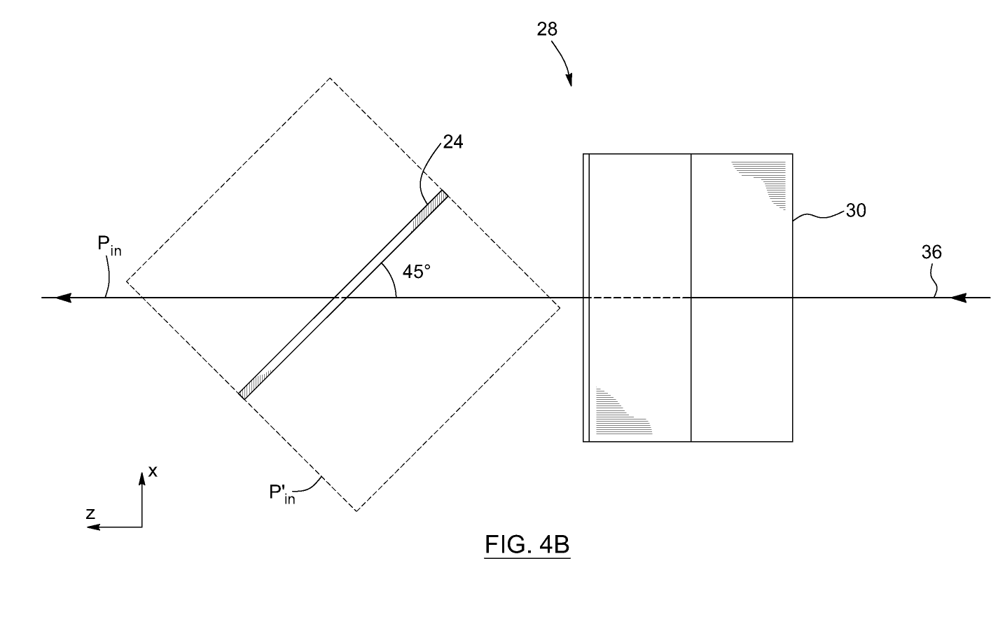

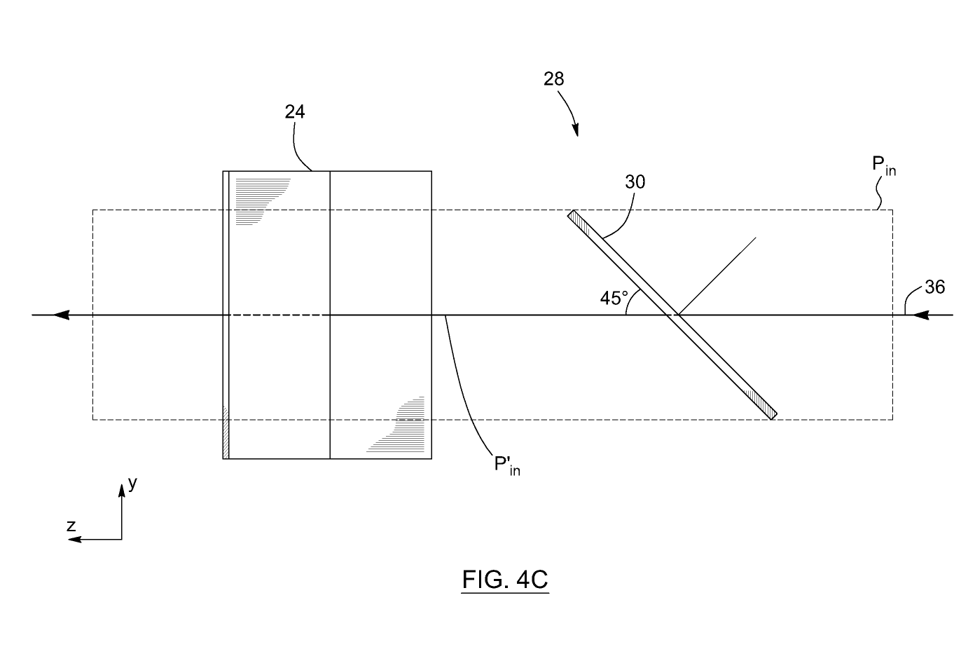

Referring to FIGS. 4A, 4B and 4C, the relative positioning of a primary and compensation optical elements 24 and 30 used in transmission according to one embodiment is illustrated. In this example the compensation optical element 30 is shown upstream the primary optical element 24 such as would be appropriate for a CARS system as shown above, but their position could be reversed for other applications.

Each of the primary and compensation optical elements 24 and 30 has a corresponding incidence surface A′ and A on which the light beam 36 impinges along a corresponding impinging direction 38. As explained above, a normal vector N′ and

N to each incidence surface A′ and A and the corresponding impinging direction 38 define together a plane of incidence denoted Pᵢₙ and Pᵢₙ. By convention, “p” and “s” polarization components are defined as being respectively aligned with and perpendicular to this plane of incidence. In the illustrated example a Cartesian reference system XYZ is used, and the light propagation axis is arbitrarily designated as the Z axis. By way of example, the primary optical element 24 is oriented at 45° with respect to the propagation axis Z in the XZ plane. Using the convention defined above, the plane of incidence Pᵢₙ of the primary optical element 24 is aligned with the XZ plane, and the p and s polarization components therefore oscillate in the X and Y directions, respectively.

In order to obtain the desired polarization compensation, the compensation optical element 30 is preferably oriented such that its plane of incidence Pᵢₙ is orthogonal to the plane of incidence Pᵢₙ′ of the primary optical element 24. In the illustrated example, this is achieved by orienting the compensation optical element 30 with an angle of 45° angle with the propagation axis Z in the YZ plane. As a result, the p polarization component oscillates along the Y direction, and the s polarization component along the X direction. Of course, the reference frame shown herein is given for illustrative purposes only. Additionally, one skilled in the art will readily understand that additional optical elements between the two optical elements may change the orientation of the polarisation components of the light beam (e.g., a polarization-rotating periscope), and that the relative orientation of the optical elements should be changed accordingly.

The polarization state of any light beam 36 can be defined as first and second polarization components, each oriented along first and second orthogonal (and arbitrary) optical axes. It will be readily understood that in the example described above, if the light beam 36 impinges on the primary optical element 24 with the first polarization component corresponding to the p polarization component and the second polarization component corresponding to the s polarization component, than the light beam will impinge on the compensation optical element 30 with the first polarization component corresponding to the s polarization component and the second polarization component corresponding to the p polarization component. In other words, the relative orientation of the primary and compensation optical elements is such that the p and s polarization components are inverted.

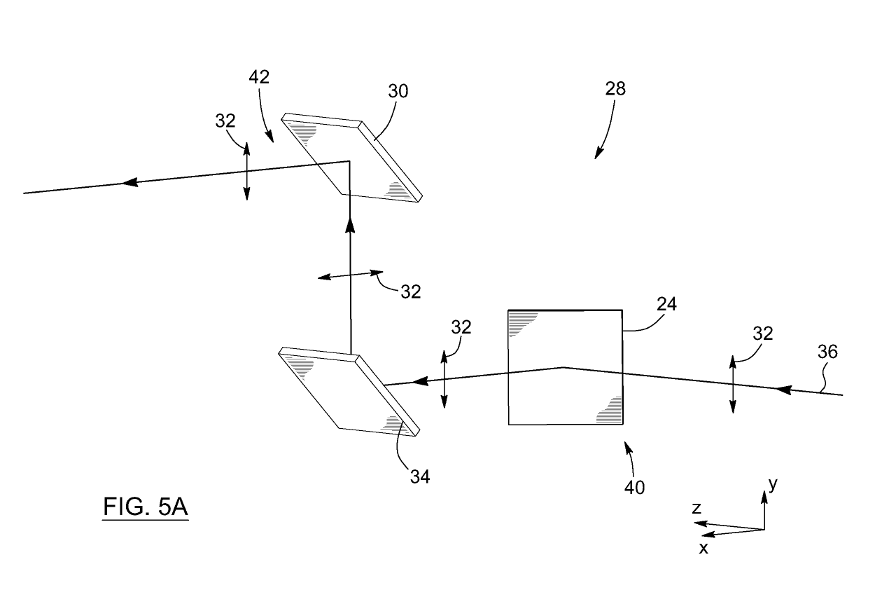

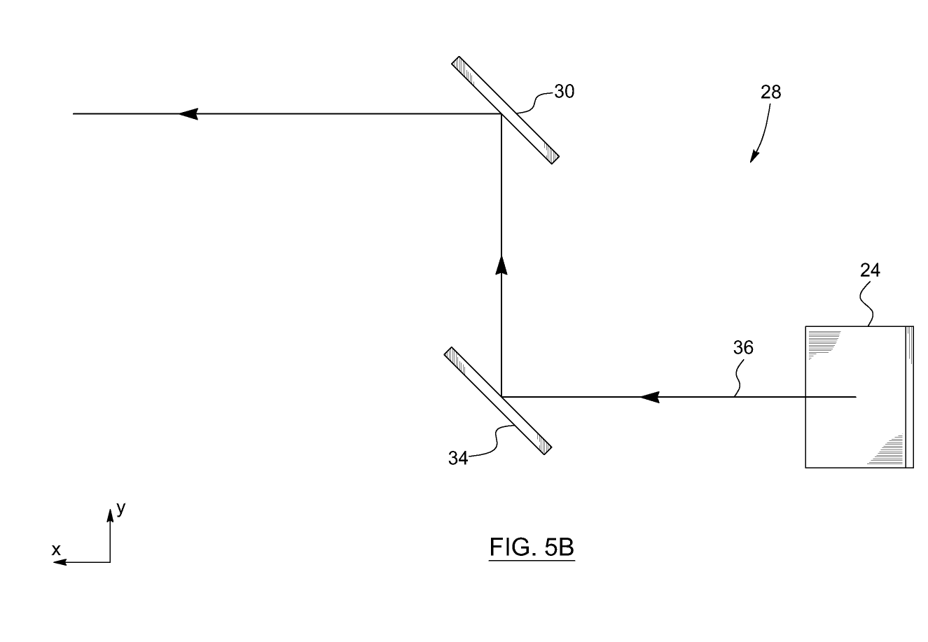

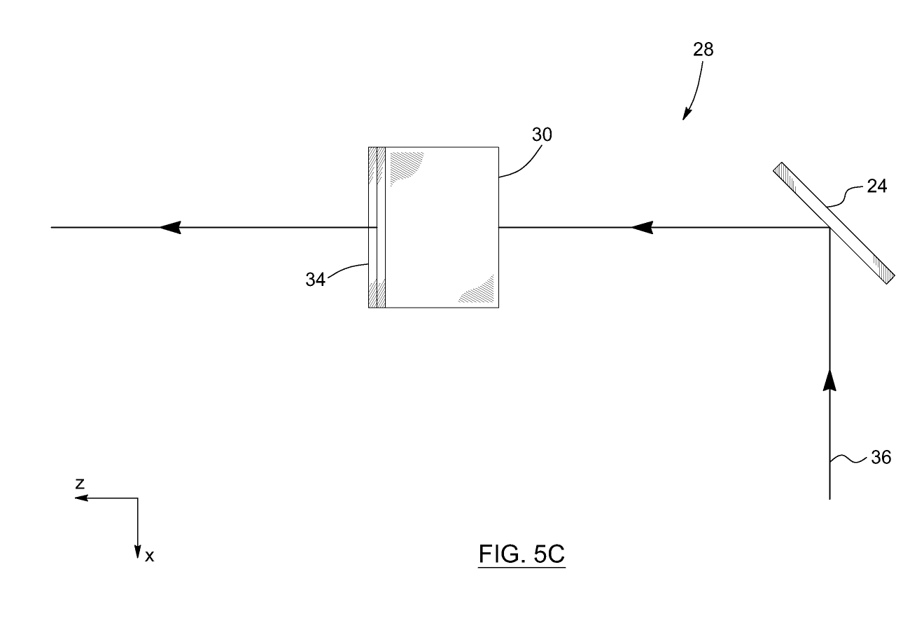

Referring to FIGS. 5A, 5B and 5C, the relative positioning of primary and compensation optical elements 24 and 30 used in reflection according to one embodiment is illustrated. In this embodiment, the primary and compensation optical elements 24 and 30 are disposed in a periscope-like configuration. Such a configuration is useful in applications such as CARS, where the compensation optical element could interfere with the basic operation of the system, but in other applications, for example polarization-resolved SHG applications, the primary and compensation optical elements could be in a direct line of sight of each other without departing from the scope of the present invention.

In the illustrated example the primary optical element 24 defines a periscope input 400 and the compensation optical element defines a periscope output 42. In a different embodiment the periscope input 40 could be defined by the compensation optical element 30 and the periscope output by the primary optical element 24. A periscope mirror 34 is disposed in the path of the light beam 36 between the periscope input 40 and output 42.

In the illustrated embodiment a Cartesian reference system XYZ is used again, and the initial propagation direction of the light beam 36 is arbitrarily set along the Z axis. As mentioned above the compensation optical element 30 may be positioned either upstream or downstream the primary optical element 24 in the path of the reflected light beam 36, their order generally depending on the design of the optical system for a given application, and is shown downstream in the illustrated embodiment by way of example only. In the illustrated example, the primary optical element 24 is shown to make a 45° angle with the propagation direction Z in the XZ plane, and its plane of incidence Pᵢₙ coincides the XZ plane. The arrow 32, aligned with the Y axis, represents the s polarization component of the light beam incident of the primary optical element 24. The p polarization component (not shown) coincides with the X axis.

In the illustrated configuration, the light beam 36 is first reflected by the primary optical element 24, and deviated to propagate along the X axis. The light beam is then incident on the periscope mirror 34 which forms a 45° angle with the new propagation axis X in the XY plane, therefore reflecting the light beam 36 to now propagate along the Y direction. As a result, the polarization component of the light beam 36 which was initially along the Y direction now oscillates along the X direction. Since this polarization component was orthogonal to the plane of incidence of the primary optical element 24, i.e. the initial s polarization state, it should be incident along the plane of incidence of the compensation optical element 30, i.e. constitute the p polarization state. The compensation optical element 24 is therefore disposed so that its plane of incidence coincides with the XY plane. By way of example, the compensation optical element 30 is shown as making a 45° angle with respect to the propagation axis Y in the XY plane.

It will be readily understood that in the examples shown above, the illustrated optical elements and mirrors are shown oriented at 45° with respect to the propagation axis of the incident light beam to facilitate the reference to a Cartesian coordinate system for illustrative purposes, and that in practice the light beam may make a different angle with these optical components without departing from the scope of the present invention.

Advantageously, a polarization-maintaining module such as described above may be integrated into the original design of an optical system, or a pre-existing system may be easily adapted to incorporate such a module.

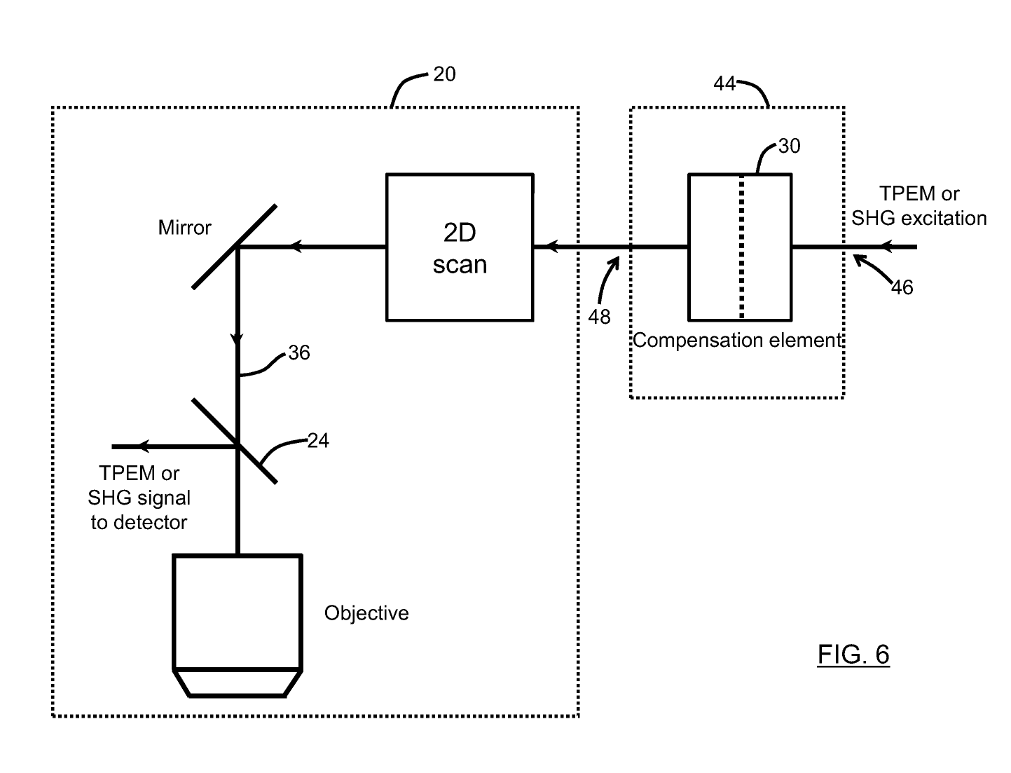

According to an aspect of the invention, there is therefore provided a method for making polarization-independent an optical system having as input or output a light beam having a polarization state out of multiple possible polarization states. Referring to FIG. 6, an example of an adapted optical system 20 resulting from such a method is shown by way of example. The illustrated configuration is suitable for TPEM or SHG applications, but it will be readily understood that it is shown by way of example only.

The optical system 20 is understood to include including a primary optical element 24 as explained above, therefore having polarization-altering characteristics and being functionally disposed within the optical system to transmit or reflect a light beam 36. Therefore, the transmitting or reflecting of the light 36 beam alters its polarization state according to these polarization-altering characteristics

The method first involves providing a compensation optical element 30 having substantially the same polarization-altering characteristics as the primary optical element. As mentioned above, both the primary and compensation optical elements 24 and 30 can be dichroic elements, filters having an anti-reflection layer, or the like. The compensation optical element 30 may be integrated inside the optical system 20 or combined therewith as an external component. It may be provided at the input or output thereof, depending on the nature and trajectory of the light beam whose polarization is to be maintained. More than one compensation optical element may be provided if the polarization of different light beams is to be maintained within a same optical system 20. For example both the reflected and the transmitted light from a dichroic primary optical element may need to be maintained, and/or different compensation optical elements may be paired with different primary optical elements within the system.

The method also involves disposing the compensation optical element 30 in a path of the light beam 36, either upstream or downstream the optical system to transmit or reflect this light beam 36. The compensation optical element 30 is oriented with respect to the light beam 36 such that the transmitting or reflecting of the light beam 36 alters its polarization state in a manner opposite to the altering of this polarization state by the primary optical element 24. This is true for any one of the possible polarization states. This is preferably accomplished by orienting the compensation optical element 30 such that its plane of incidence is orthogonal to the plane of incidence of the primary optical element 24.

In one example, the compensation optical element may be provided in a casing 44 having a light input 46 and a light output 48. The compensation optical element 30 can be mounted in the casing 44 according to a predetermined orientation with respect to the light input 46 and output 48. This predetermined orientation can be tailored to a particular model or configuration of the optical system, taking into consideration the orientation and position of the primary optical element 24 therein. Advantageously, the relative orientation of all these elements may be such as to facilitate the proper alignment of the compensation optical element.

The compensation optical element may be provided upstream or downstream the primary optical element, as dictated by the requirements of the overall design of the optical system. Both the primary and compensation optical elements may be used either in transmission or in reflection. In the reflexion case, a periscope-like configuration such as described above may optionally be used, and a periscope mirror provided in conjunction with the compensation optical element.

Additional optical components such as mirrors, lens, beamsplitters or the like may also be provided to further affect or redirect light within the system. In some embodiment, such components may be included within the casing. In the case where additional beamsplitters or other polarization affecting components are introduced, it may be possible to also compensate for their polarization altering characteristics with an additional compensation optical element, paired with polarization-altering component.

Of course, numerous modifications could be made to the embodiments above without departing from the scope of the present invention as defined in the appended claims.

1. A polarization-maintaining module for an optical system in which propagates a light beam having a polarization state out of multiple possible polarization states, the polarization-maintaining module comprising:
a primary optical element having polarization-altering characteristics, the primary optical element being functionally disposed within the optical system to transmit or reflect the light beam, the transmitting or reflecting of the light beam altering the polarization state thereof according to said polarization-altering characteristics; and
a compensation optical element disposed in a path of the light beam to transmit or reflect the same, the compensation optical element having substantially the same polarization-altering characteristics as the primary optical element, the compensation optical element being oriented with respect to said light beam such that the transmitting or reflecting of the light beam thereby alters the polarization state of the light beam in a manner opposite to the altering of said polarization state by the primary optical element for any one of said possible polarization states.

2. The polarization-maintaining module according to claim 1, wherein the primary and compensation optical elements are dichroic elements.

3. The polarization-maintaining module according to claim 1, wherein the primary and compensation optical elements are filters comprising an anti-reflection layer.

4. The polarization-maintaining module according to claim 1, wherein the compensation optical element is disposed upstream of the primary optical element.

5. The polarization-maintaining module according to claim 1, wherein the compensation optical element is disposed downstream of the primary optical element.

6. The polarization-maintaining module according to claim 1, wherein:
each of the primary and compensation optical elements has an incidence surface on which the light beam impinges along a corresponding impinging direction, a normal vector to each incidence surface and the corresponding impinging direction defining together a plane of incidence; and
the compensation optical element is oriented such that the plane of incidence thereof is orthogonal to the plane of incidence of the primary optical element.

7. The polarization-maintaining module according to claim 1, wherein:
the polarization state of the light beam is defined by first and second polarization components oscillating along first and second orthogonal optical axes;
each of the primary and compensation optical elements have an incidence surface on which the light beam impinges along a corresponding impinging direction, a normal vector to each incidence surface and the corresponding impinging direction defining together a plane of incidence, “p” and “s” polarization components being defined by convention as being respectively aligned with and perpendicular to said plane of incidence;
the light beam impinges on the primary optical element with the first polarization component corresponding to the p polarization component and the second polarization component corresponding to the s polarization component; and
the light beam impinges on the compensation optical element with the first polarization component corresponding to the s polarization component and the second polarization component corresponding to the p polarization component.

8. The polarization-maintaining module according to claim 1, wherein the primary and compensation optical elements transmit the light beam.

9. The polarization-maintaining module according to claim 1, wherein the primary and compensation optical elements reflect the light beam.

10. The polarization-maintaining module according to claim 9, wherein the primary and compensation optical elements are disposed in a periscope-like configuration, one of the primary and compensation optical elements defining a periscope input and the other one of the primary and compensation elements defining a periscope output, said module further comprising a periscope mirror disposed in a path of said light beam between the periscope input and output.

11. Use of a polarization-maintaining module according to claim 1, in an optical system in which the light beam is composed of multiple light beam components.

12. Use of a polarization-maintaining module according to claim 2 in an optical system configured as one of a Second-Harmonic Imaging microscope, a One-Photon or Multiphoton Excitation Fluorescence or phosphorescence system, a Coherent Anti-Stokes Raman Scattering system, a Stimulated Raman Scattering system, a Sum-Frequency Generation system, a Raman spectroscopic system, an Infrared spectroscopic system, a Polarization spectroscopic system and a Stimulated Emission Depletion Microscope.

13. A method for making polarization-independent an optical system having as input or output a light beam having a polarization state out of multiple possible polarization states, the optical system including a primary optical element having polarization-altering characteristics, the primary optical element being functionally disposed within the optical system to transmit or reflect the light beam, the transmitting or reflecting of the light beam altering the polarization state thereof according to said polarization-altering characteristics, the method comprising:
a) providing a compensation optical element having substantially the same polarization-altering characteristics as the primary optical element;
b) disposing the compensation optical element in a path of the light beam upstream or downstream the optical system to transmit or reflect said light beam, and orienting said compensation optical element with respect to the light beam such that the transmitting or reflecting of the light beam thereby alters the polarization state of the light beam in a manner opposite to the altering of said polarization state by the primary optical element of the optical system for any one of said possible polarization states.

14. The method according to claim 13, wherein the primary and compensation optical elements are dichroic elements or filters comprising an anti-reflection layer.

15. The method according to claim 13, wherein:
each of the primary and compensation optical elements has an incidence surface on which the light beam impinges along a corresponding impinging direction, a normal vector to each incidence surface and the corresponding impinging direction defining together a plane of incidence; and
step b) comprises orienting the compensation optical element such that the plane of incidence thereof is orthogonal to the plane of incidence of the primary optical element.

16. The method according to claim 13, wherein the primary and compensation optical elements reflect the light beam, the method further comprising providing a periscope mirror in the path of the light beam, the periscope mirror and the compensation optical element being disposed such that they form a periscope-like configuration with the primary optical element wherein one of the primary and compensation optical elements defines a periscope input, the other one of the primary and compensation elements defines a periscope output and the periscope mirror extends between the periscope input and output.

17. The method according to claim 13, wherein the providing of step a) comprises providing a casing having a light input and a light output, the compensation optical element being mounted therein according to a predetermined orientation with respect to said light input and output.
